(19) United States
(12) Patent Application Publication
(10) Pub. No.: US 2024/0244471 A1
(43) Pub. Date: Jul. 18, 2024

(54) DATA COLLECTION ENHANCEMENTS FOR NETWORK SLICING

(71) Applicant: QUALCOMM Incorporated, San Diego, CA (US)

(72) Inventors: Shankar KRISHNAN, San Diego, CA (US); Peng CHENG, Beijing (CN); Rajeev KUMAR, San Diego, CA (US); Xipeng ZHU, San Diego, CA (US); Luis Fernando Brisson LOPES, Swindon (GB); Jianhua LIU, Beijing (CN)

(21) Appl. No.: 18/682,291

(22) PCT Filed: Sep. 29, 2021
(86) PCT No.: PCT/CN2021/121645

§ 371 Date: Feb. 8, 2024

(51) Int. Cl. H04W 24/10; H04W 24/02; H04W 74/08; H04W 74/0833; H04W 84/18

(52) U.S. Cl. CPC H04W 24/10; H04W 24/02; H04W 74/0833; H04W 74/0875; H04W 84/18

(57) ABSTRACT

Certain aspects of the present disclosure provide techniques for enhanced network data collection reporting. According to one aspect, a wireless node generates at least one data collection report including network slicing information and transmits the data collection report.

### INTRODUCTION

Aspects of the present disclosure relate to wireless communications, and more particularly, to techniques for wireless network reporting using radio access network (RAN) slicing information.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communications by a wireless node. The method generally includes generating at least one data collection report including network slicing information and transmitting the data collection report.

One aspect provides a method for wireless communications. The method generally includes receiving, from a wireless node, at least one data collection report including network slicing information, and processing the data collection report.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A-3D depict various example aspects of data structures for a wireless communication network.

FIG. 4 is a call-flow diagram illustrating an example four-step random access channel (RACH) procedure, in accordance with certain aspects of the present disclosure.

FIG. 5 is a call-flow diagram illustrating an example two-step RACH procedure, in accordance with certain aspects of the present disclosure.

FIG. 6 is a call-flow diagram depicting an example of RACH reporting.

FIG. 7 is a call-flow diagram depicting an example of data collection reporting for slice-specific procedures, in accordance with certain aspects of the present disclosure.

FIG. 8 depicts examples of random-access channel (RACH) resource selection, in accordance with certain aspects of the present disclosure.

FIG. 9 is a call-flow diagram illustrating a slice-specific handover reporting procedure between two wireless nodes, in accordance with certain aspects of the present disclosure.

FIG. 10 illustrates example operations for wireless communications by a wireless node, in accordance with some aspects of the present disclosure.

FIG. 11 illustrates example operations for wireless communications by a wireless node, in accordance with some aspects of the present disclosure.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums that may enhance wireless network data collection reporting by including radio access network (RAN) slicing information.

To help optimize network performance, a wireless communication device may generate a data collection report related to certain procedures. For example, a UE may send a data collection report after the success or failure self-organizing network (SON) or minimization of driving (MDT) procedure. The data collection report includes certain information about the preceding procedure that may allow the UE or a base station (BS) to optimize subsequent SON or MDT procedures. The data collection report is often a next generation radio access network report (NG-RAN).

Aspects of the present disclosure may enhance data collection reports by including slice-specific information related to the corresponding procedure. Slicing generally refers to a network architecture that enables independent logical networks on a shared physical network structure. Each logical network, generally referred to as a slice, may isolate and support a specific 5G-NR service (e.g., enhanced mobile broadband (eMBB), millimeter wave (mmWave), machine type communications (MTC), and/or mission critical targeting ultra-reliable, low-latency communications (URLLC)).

Certain network procedures may be optimized, for example, to prioritize certain (e.g., considered sensitive or critical) slices. For example, slice-specific RACH procedures may allow for different RA resources to allow certain slices to be prioritized during a RACH procedure. In such cases, a UE may have separate PRACH configurations (e.g., transmission occasions of time-frequency domain and preambles) for different slices or slice groups.

Aspects of the present disclosure may help optimize such slice-specific procedures by providing slice-specific information in data collection reports exchanged between UEs and BSs, and/or between a source BS and a target BS. Such slicing information may be used to help optimize the success of future network procedures operating on a certain slice. For example, a data collection report from a UE including a procedure's failure rate on an identified slice may help the network determine whether to make any changes to configurations of other procedures set to occur on the identified slice. Enhanced data collection reports also allow networks to predetermine, for example, the amount of traffic on a certain slice, the priority of operations occurring on a certain slice, or an appropriate configuration for slice-specific resources based on previous procedures.

### Introduction to Wireless Communication Networks

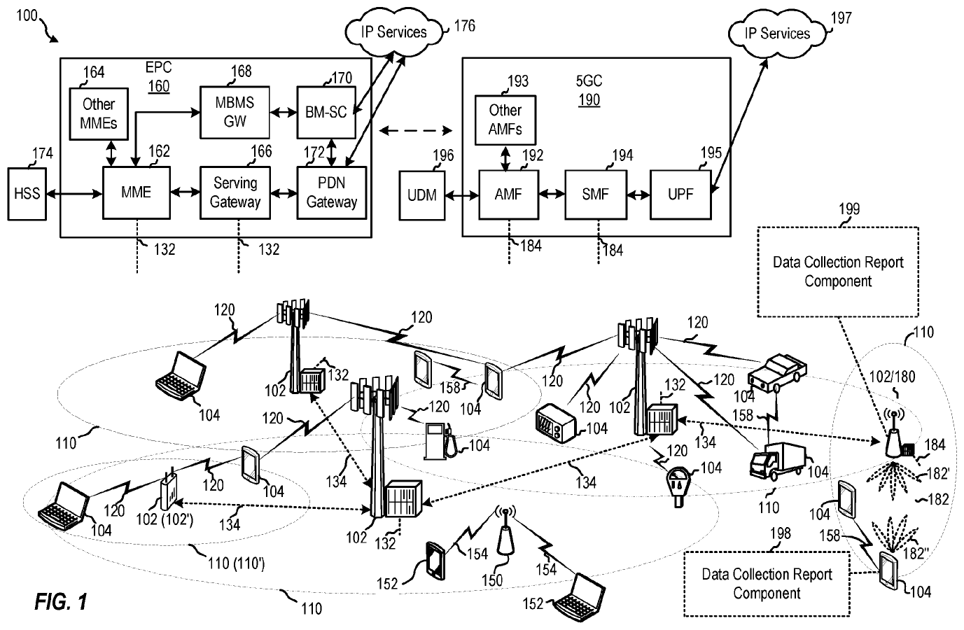

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes a data collection report component 199, which may be configured to transmit or receive data collection reports based on slicing information. Wireless network 100 further includes a data collection report component 198, which may be configured to transmit or receive data collection reports based on slicing information.

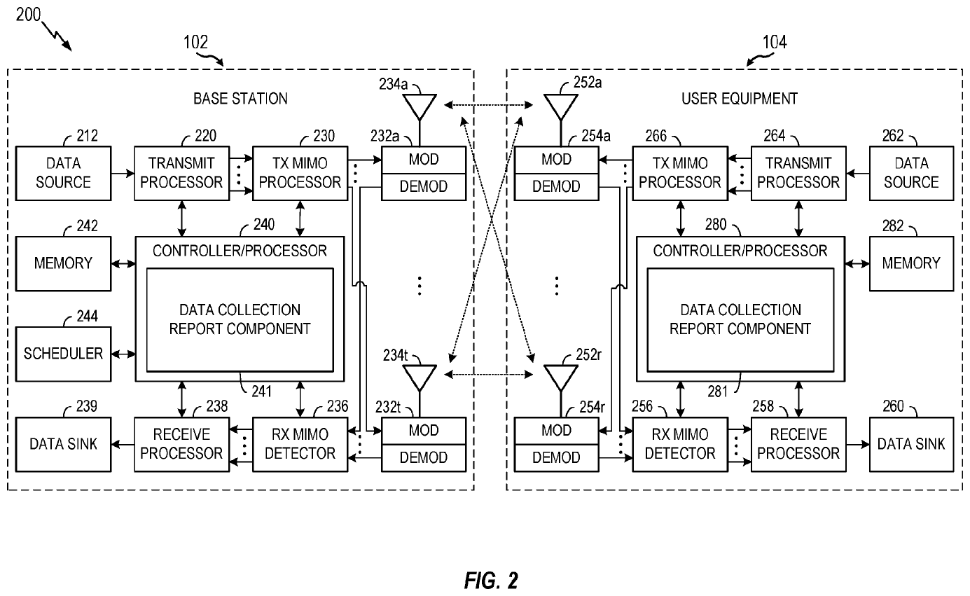

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes a data collection report component 241, which may be representative of a data collection report component 199 of FIG. 1. Notably, while depicted as an aspect of controller/processor 240, a data collection report component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes a data collection report component 281, which may be representative of a data collection report component 198 of FIG. 1. Notably, while depicted as an aspect of controller/processor 280, a data collection report component 281 may be implemented additionally or alternatively in various other aspects of user equipment 104 in other implementations.

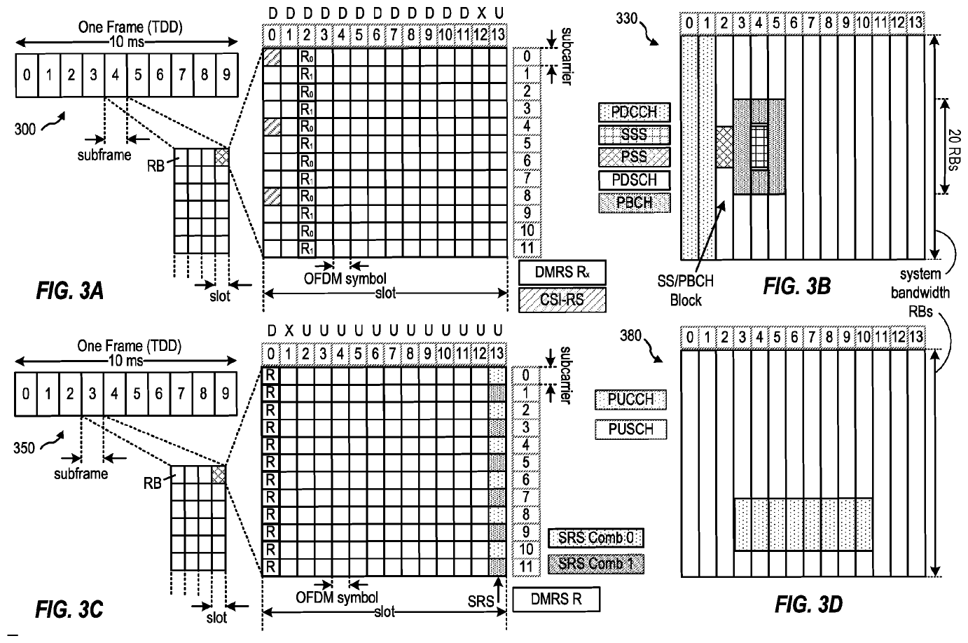

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Example RACH Procedures

A random-access channel (RACH) is so named because it refers to a wireless channel (medium) that may be shared by multiple UEs and used by the UEs to (randomly) access the network for communications. For example, the RACH may be used for call setup and to access the network for data transmissions. In some cases, RACH may be used for initial access to a network when the UE switches from a radio resource control (RRC) connected idle mode to active mode, or when handing over in RRC connected mode. Moreover, RACH may be used for downlink (DL) and/or uplink (UL) data arrival when the UE is in RRC idle or RRC inactive modes, and when reestablishing a connection with the network.

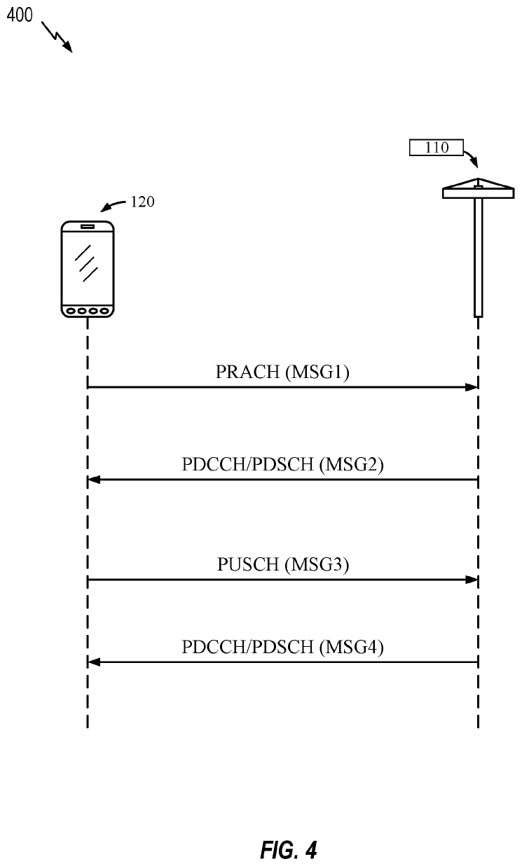

FIG. 4 is a timing (or “call-flow”) diagram 400 illustrating an example four-step RACH procedure, in accordance with certain aspects of the present disclosure. A first message (MSG1) may be sent from the UE 120 to BS 110 on the physical random access channel (PRACH). In this case, MSG1 may only include a RACH preamble. BS 110 may respond with a random access response (RAR) message (MSG2) which may include the identifier (ID) of the RACH preamble, a timing advance (TA), an uplink grant, cell radio network temporary identifier (C-RNTI), and a back off indicator. MSG2 may include a PDCCH communication including control information for a following communication on the PDSCH, as illustrated. In response to MSG2, MSG3 is transmitted from the UE 120 to BS 110 on the PUSCH. MSG3 may include one or more of a RRC connection request, a tracking area update request, a system information request, a positioning fix or positioning signal request, or a scheduling request. The BS 110 then responds with MSG 4 which may include a contention resolution message.

In some cases, to speed access, a two-step RACH procedure may be supported. As the name implies, the two-step RACH procedure may effectively “collapse” the four messages of the four-step RACH procedure into two messages.

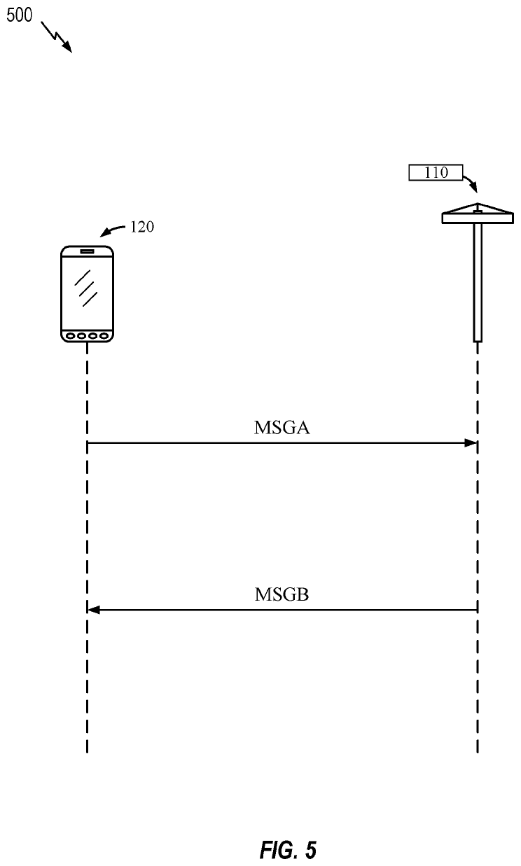

FIG. 5 is a timing diagram 500 illustrating an example two-step RACH procedure, in accordance with certain aspects of the present disclosure. A first enhanced message (msgA) may be sent from the UE 120 to BS 110. In certain aspects, msgA includes some or all the information from MSG1 and MSG3 from the four-step RACH procedure, effectively combining MSG1 and MSG3. For example, msgA may include MSG1 and MSG3 multiplexed together such as using one of time-division multiplexing or frequency-division multiplexing. In certain aspects, msgA includes a RACH preamble for random access and a payload. The msgA payload, for example, may include the UE-ID and other signaling information (e.g., buffer status report (BSR)) or scheduling request (SR). BS 110 may respond with a random access response (RAR) message (msgB) which may effectively combine MSG2 and MSG4 described above. For example, msgB may include the ID of the RACH preamble, a timing advance (TA), a back off indicator, a contention resolution message, UL/DL grant, and transmit power control (TPC) commands.

In a two-step RACH procedure, the msgA may include a RACH preamble and a payload. In some cases, the RACH preamble and payload may be sent in a msgA transmission occasion.

The random access message (msgA) transmission occasion generally includes a msgA preamble occasion (for transmitting a preamble signal) and a msgA payload occasion for transmitting a PUSCH. The msgA preamble transmission generally involves:
(1) selection of a preamble sequence; and
(2) selection of a preamble occasion in time/frequency domain (for transmitting the selected preamble sequence).

The msgA payload transmission generally involves:
(1) construction of the random access message payload (DMRS/PUSCH); and
(2) selection of one or multiple PUSCH resource units (PRUs) in time/frequency domain to transmit this message (payload).

In some cases, a UE monitors SSB transmissions which are sent (by a gNB using different beams) and are associated with a finite set of time/frequency resources defining RACH occasions (ROs) and PRUs. As will be described in greater detail below, upon detecting an SSB, the UE may select an RO and one or more PRUs associated with that SSB for a msgA transmission. The finite set of ROs and PRUs may help reduce monitoring overhead (blind decodes) by a base station.

There are several benefits to a two-step RACH procedure, such as speed of access and the ability to send a relatively small amount of data without the overhead of a full four-step RACH procedure to establish a connection (when the four-step RACH messages may be larger than the payload).

The two-step RACH procedure can operate in any RRC state and any supported cell size. Networks that uses two-step RACH procedures can typically support contention-based random access (CBRA) transmission of messages (e.g., msgA) within a finite range of payload sizes and with a finite number of MCS levels.

### Aspects Related to Data Collection Reports

In some cases, to enhance the various procedures, a network can configure the UE to collect and report various types of data. Such reports may include reports used for self-organizing networks (SON) and minimization of driving test (MDT) reports.

SON generally refers to an automation technology designed to facilitate the planning, configuration, and management of mobile radio access networks (RANs). Some SON functionality and behavior has been defined and specified in 3GPP (3rd Generation Partnership Project). Example SON features for LTE include Physical Cell Identity (PCI) selection, Automatic Neighbor Relation (ANR) detection, Mobility Robustness Optimization (MRO), and Mobility Load Balancing (MLB), and Energy Savings (ES).

ANR functionality is generally designed to relieve the operator from the burden of manually managing Neighbor Relations (NRs). ANR functionality generally resides in the base station (eNB/gNB) and manages a conceptual Neighbor Relation Table (NRT). Located within ANR, the Neighbor Detection Function finds new neighbors and adds them to the NRT. ANR also contains the Neighbor Removal Function which removes outdated NRs.

MDT generally refers to a feature that enables operators to utilize UEs to collect radio measurements and associated location information, in order to assess network performance while reducing the operator expense associated with traditional drive tests. In LTE, the MDT framework typically involves collecting data from UE (over the cellular or “Uu” link) and RAN for detecting potential issues for optimizing different procedures, such as random access channel (RACH), radio link failure (RLF), and connection establishment. MDT also helps network build coverage maps via location reporting.

In NR, the NR SON/MDT framework may take advantage or build on LTE solutions as baseline wherever applicable. The LTE SON/MDT framework may also enhanced to take NR new architectures and features into account. Such features and architectures include multi-RAT dual connectivity (MR-DC), central unit and distributed unit (CU-DU) split architectures, enhanced beam management, and inactive states.

### Example Slice-Specific Network Procedures

Aspects of the present disclosure propose various techniques that may be considered enhancements of data collection (e.g., SON/MDT) reporting for network procedures that take into account network slicing information.

For example, the techniques may help enhance Cell Global Identity (CGI) reporting and Mobility Robust Optimization (MRO) reporting, such as radio link failure (RLF) reporting (e.g., for legacy handover and condition handover-CHO). The techniques may also help enhance connection establishment failure (CEF) reporting, MDT reporting (e.g., logged and immediate MDT reporting), and Mobility History Information reporting. The techniques may also help enhance other types of reporting, such as load balancing (e.g., reporting load metrics, such as PRB usage per beam), unified access control (UAC) reporting, and automatic neighbor relation (ANR) reporting.

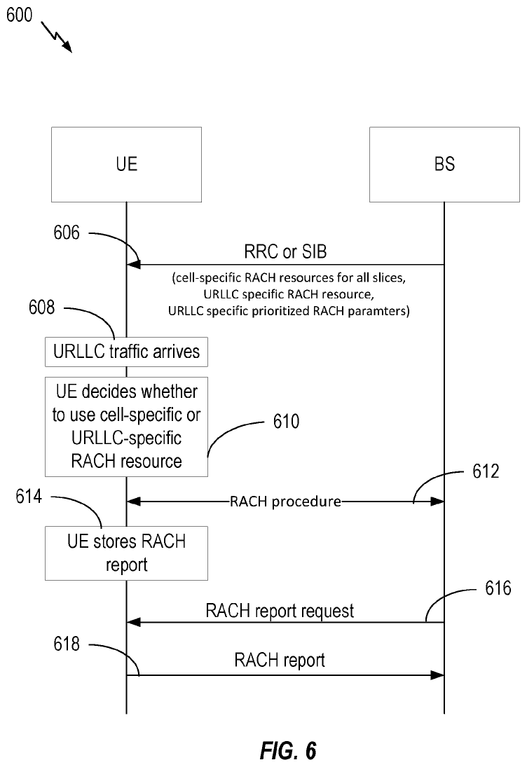

The techniques may also help enhance slice specific RACH procedures, such as that shown in FIG. 6, by including network slicing information for RACH reporting.

A UE may generate a wireless communication report after the success or failure of a 2-step and/or 4-step procedure. The report may include certain information about a preceding RACH procedure that may be used to optimize of subsequent RACH procedures. For 4-step RACH procedures, optimization information in the report may a include cell global identity (CGI) of cell that performed a successful random access procedure, the random access purpose, the frequency information of the bandwidth part (BWP) where random access is performed (e.g., pointA, locationAndBandwidth, SCS), the frequency information of random access resources (e.g., msg1-FDM, msg1-SCS), the contention detection per random access attempt, and the number of preambles sent on a certain single sideband (SSB) or channel state information resource signal (CSI-RS) beam.

FIG. 6 depicts a call-flow diagram 600 for an example slice-specific RACH procedure involving a user equipment (UE) and a base station (BS). At 606, the UE determines slice priority. At 606, the BS may configure, using radio resource control (RRC) or single sideband (SBB), a UE with isolated RACH resources and/or prioritized RACH parameters different from cell specific RACH. At 608, arriving traffic (e.g., ultra-reliable low latency communication (URLLC) traffic) may trigger the UE to perform a RACH procedure.

At 610, the UE decides whether to use cell-specific or URLLC-specific RACH resources. For example, non-access stratum (NAS) may indicate a slice group identifier (ID) to an access stratus (AS) and a UE's AS may select corresponding RACH resources or parameters for RACH access. The same slice group signaling for cell reselection may be applied to slice-specific RACH.

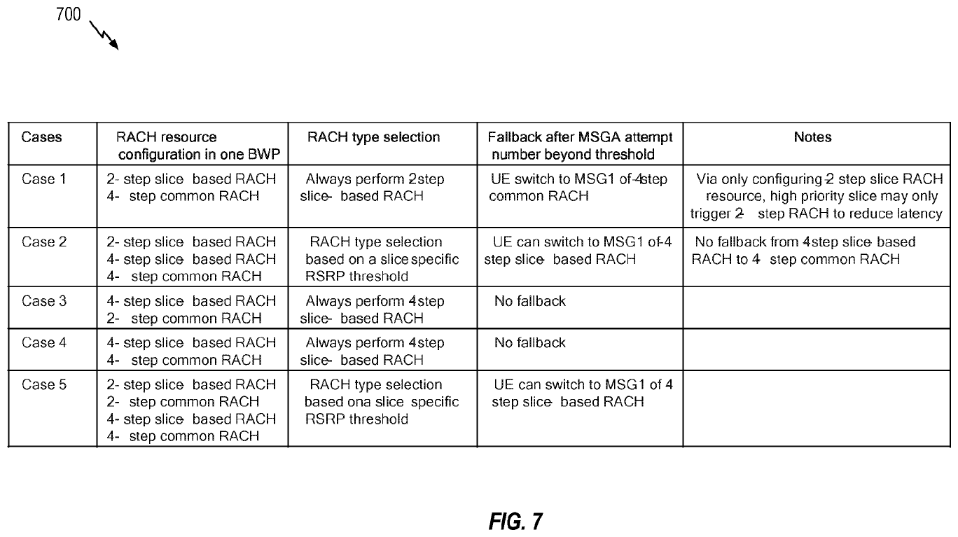

FIG. 7 illustrates a table 700 for examples of RACH resource selection using slice-specific RACH resources. To support legacy UE and non-urgent slicing, common RACH resources may configured in a same bandwidth part (BWP). FIG. 7 illustrates five use-cases for RACH type selection and fallback. The second column shows the example RACH resource configuration in one bandwidth part. The third column shows the RACH type that may be selected for the RACH procedure. The fourth column shows the fallback procedure that may take place if the selected RACH procedure fails.

In the first case illustrated in row 1 of FIG. 7, a UE may be configured to perform a 2-step slice-based RACH, or a 4-step common RACH. In this case, if the 2-step RACH procedure fails, the UE may switch to MSG1 of 4-step common RACH during fallback as illustrated in FIG. 4. In some cases, the network may only configure a 2-step slice RACH resource, so a high priority slice may only trigger 2-step RACH to reduce latency.

In the second case illustrated in row 2 of FIG. 7, a UE may be configured to perform a 2-step slice-based RACH, 4-step slice-based RACH, or 4-step common RACH. In this case, the RACH type selection may be based on a slice-specific reference signal received power (RSRP) threshold. If the RACH procedure fails, a UE may switch to MSG1 of 4-step slice-based RACH. In this case, there may no fallback from a 4-step slice-based RACH procedure to 4-step common RACH procedure.

In the third case illustrated in row 3 of FIG. 7, a UE may be configured to perform 4-step slice-based RACH or 2-step common RACH procedure. In this case, the UE may perform a 4-step slice-based RACH, with no fallback procedure in this case.

In the fourth case illustrated in row 4 of FIG. 7, a UE may be configured to perform 4-step slice-based RACH or a 4-step common RACH. In this case, the UE may perform the 4-step slice-based RACH procedure, with no fallback procedure in this case.

In the fifth case illustrated in row 5 of FIG. 7, a UE may be configured with a 2-step slice-based RACH, 2-step common RACH, 4-step slice-based RACH, or 4-step common RACH. In this case, the UE may perform a RACH type selection based on a slice-specific RSRP threshold. If the 2-step slice-based RACH procedure fails, the UE may switch to MSG1 of a 4-step slice-based RACH procedure.

Returning to FIG. 6, the RACH procedure (e.g., 2-step or 4-step) is performed, at 612, based on the selected resources. At 614, the UE generates and stores a RACH report. At 616, the BS requests the RACH report. At 618, the UE sends the RACH report to the BS.

In some cases, a report may be enhanced to include optimization parameters for 2-step random access procedures. By enhancing 2-step RACH reports, a cell may take advantage of the high-speed, low overhead capabilities associated with 2-step RACH procedures. 2-step RACH optimization parameters may include whether there is fallback from 2-step to 4-step random access attempt, whether DL beam quality associated with 2-step random access resource is above or below a certain threshold, and the reference signal received power (RSRP) of downlink (DL) pathloss reference obtained before performing a 2-step random access procedure.

### Aspects Related to Wireless Network Reporting Using Network Slicing Information

Aspects of the present disclosure may help optimize slice-specific procedures, such as the slice-specific RACH procedure described above, by including network slicing information in corresponding data collection reports. For example, data collection reports with network slicing information may also help optimize parameters for (other slice-specific self-organizing network (SON) or minimization of driving (MDT) procedure reports (e.g., handover (HO), radio link failure (RLF), connection establishment failure (CEF) reports.)

As previously described, each network slice may isolate and support a specific 5G-NR service (e.g., enhanced mobile broadband (eMBB), millimeter wave (mmWave), machine type communications (MTC), and/or mission critical targeting URLLC). Each individual slice has a Single-Network Slice Selection Assistance Information (S-NSSAI) which uniquely identifies a network slice. An individual network slice performing slice-specific procedures may be associated with each procedure through its S-NSSAI, which acts as a slice identifier (ID).

A network may use slice IDs and other slice-specific information to enhance data collection reports for SON or MDT procedures. In certain cases, data collection reports comprise next generation radio access network (NG-RAN) reports.

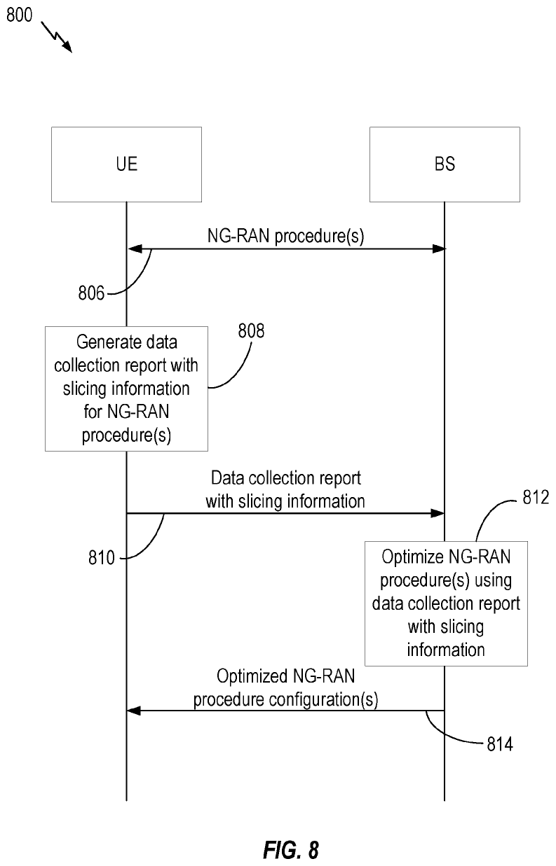

FIG. 8 depicts a call-flow diagram 800 for network data collection that includes network slicing information, in accordance with aspects of the present disclosure. Inclusion of the network slicing information in the data collection reports (e.g., NG-RAN reports) may enable optimization of corresponding network procedures based on those NG-RAN reports. At 806, a base station (BS) and UE perform an NG-RAN procedure (or procedures). Based on the results of the procedure, at 808, the UE generates a data collection report for the NG-RAN procedure, which includes slice-specific information for the procedure. NG-RAN reports and procedures may include reports and procedures for RACH, MDT logging, RLF, CEF, and HO.

At 810, the UE sends the data collection report with the slice-specific information to the BS, which in turn optimizes the procedures at 812 based on the slice-specific information within the data collection report. At 814, the BS sends a new NG-RAN procedure configuration to the UE that has been optimized with respect to the slice specific information.

According to certain aspects of the present disclosure, a data collection report generated for a RACH procedure (a RACH report) may be enhanced by including slice-specific information. In cases where the UE/network may decide whether to do a slice-based RACH or a common RACH, based on a slice-specific RSRP threshold, future RACH selection procedures may be optimized where the network is aware of information regarding preceding RACH procedures.

According to certain aspects of the present disclosure, when SON or MDT procedures, including 2-step and 4-step slice-level RACH procedures, occur on a 5G-NR slice, the network may optimize those procedures through resource isolation. For example, by performing a slice-level RACH procedure on a certain slice, a network entity may provide pledged random access resources for the sensitive slices (e.g., slices with heavy network traffic) by configuring information indicating slice-specific RACH resources based on the network slicing information included in the RACH report. By utilizing a slice-specific MDT or SON procedures like slice-specific RACH, the network may support, for example, a dedicated eMBB slice, or URLLC slice. Slice-specific RACH enforced isolation may allocate resources for the sensitive slice, reducing resources constraints by utilizing dedicated resources (e.g., dedicated preambles and the like).

In another example, a network may benefit from slice-level report optimization through slice access prioritization. In Rel-15/Rel-16, all slices share the same random access resources and cannot be differentiated by a network. According to the enhancements disclosed herein, a network may give priority to certain SON or MDT procedures by prioritizing slices. Prioritization may include options to enable slice-specific RACH. RACH prioritization parameters (e.g., a parameter used to scale a backoff indicator for a prioritized RACH procedure scalingFactorBI and/or a parameter indicating how quickly to ramp up transmission power for a prioritized RACH procedure power RampingStepHighPriority) may be configured for individual slices or slice groups. Additionally, a separate physical RACH (PRACH) configuration (e.g., transmission occasions of time-frequency domain and preambles) may be configured for slices or slice groups. A wireless entity may enable slice prioritization by providing a higher power-ramping step or a different scaling factor for a specific slice or slice group.

A network may give priority to slice-specific RACH in accordance with certain aspects of the present disclose. The priority of each random access prioritization parameter set may be configured via RRC, NAS, or otherwise preconfigured in subscription. A UE's AS selects the set of RACH prioritization parameters with highest priority to perform RACH. This may lead to a collision, where slice-specific RACH prioritization occurs at the same time as legacy prioritization (e.g., Mission Critical Services (MCS) or Multimedia Public Services (MPS)). Collision may lead to a UE failing to choose one or the other procedure. Collision information may be used to enhance data collection reports according to certain aspects.

If slice set priority is not configured in a network, the UE may use the preconfigured priority in a subscription. If slice set priority is not configured or pre-configured, the UE may use a fixed rule. For example, in a case where MPS/MCS and slice group priority traffic overlap, the MPS/MCS may overrule the slice/slice group. In one RACH-specific example, if a new RACH procedure is triggered by traffic associated with a slice, and there is another on-going RACH procedure, a network may abort the on-going RACH and start the new RACH procedure if slice priority of new RACH is higher than on-going RACH. If slice priority of new RACH is not higher than on-going RACH, the network may suspend the new RACH procedure

Because the network may support many slice-specific and priority-based procedures, it may beneficial to the network to track operations associated with procedures therein. For example, a network may track the number of times a RACH is aborted, and under what circumstances. Where RACH procedure is ongoing for eMBB, and URLLC traffic arrives at the UE for transmission, the UE may abort the eMBB procedure and proceed with a URLLC RACH procedure. According to certain aspects of the present disclosure, in this example, the network may record the eMBB aborted procedure and transmit that information to a BS on a report.

According to certain aspects of the present disclosure, enhancements to reports allows the network to predetermine, for example, an appropriate configuration for slice-specific RACH resources based on previous RACH procedures. A UE may enhance a NG-RAN report transmitted to a BS with one or more of the following information: Slice ID or slice group ID, the slice-specific threshold used for RACH type selection, an indication regarding whether slice-specific RACH resource were used per random access attempt, a new random access cause per random access attempt, number of times an ongoing RACH was aborted due to a higher priority RACH, number of times a new RACH was suspended due to an ongoing higher priority RACH, and an indication that there is a collision in slice-specific RACH parameters prioritization and legacy radio access network (RAN) prioritization. These enhancements may optimize the success percentage of future RACH procedures. Slice ID may indicate the slice for the RACH procedure that just occurred. This information may the network to determine what slice UE is using. Additionally, the group could note success or failure of the preceding RACH procedure, identifying the type of RACH and how it performed.

In certain cases, a BS may perform reporting enhancements and send the enhanced report to other entities. Currently, a BS may measure the number of received random access preambles during a time period over all PRACHs configured in a cell or in the SSB of the cell. The measurement is done separately for dedicated preambles, randomly selected preambles in the low range, and randomly selected preambles in the high range. The BS may also measure number of active UEs (mean/max) per DL/uplink (UL) per cell.

According to certain aspects of the present disclosure, a BS may measure number of random access attempts (i.e., MSG1/MSGA) per slice. The BS may measure this parameter if the UE fails to report it. Because a BS may perform a slice RACH procedure, there is a benefit in measuring a number of random access attempts per slice because the BS may use this measurement to optimize future RACH procedures by tracking, for example, what cells or slices are have a large amount of traffic. A BS may also measure a number of users which accessed a specific slice RACH resource, a number of active UEs (e.g., mean or max) per slice and random access attempts per slice. These measurements may help a BS to determine the load in accessing certain slice, and may be shared with neighboring network entities.

Network slicing information may also be included to enhance other forms of data collection reporting, for example, for SON or MDT related procedures. In one example, a network may optimize MDT procedures using logged MDT enhancements with slice information. Previously, a logged MDT configuration contained a list of targeted areas (using, e.g., cell global identity (CGI), type allocation code, tracking area identifier) of serving and inter-frequency neighboring cells whose measurements were logged in RRC_IDLE and RRC_INACTIVE.

According to certain aspects, logged MDT may support slice-specific reselection where slice information may be signaled in a system information block (SIB) or RRCRelease. This slice-specific reselection may occur based on the supported slice information of the current cell and neighbor cells and cell reselection priority per slice, which may be obtained using the logged MDT. In one example, an idle UE using a logged MDT with slice information may specify in a transmitted MDT report that it may only select a cell belonging to a certain slice (e.g., that provides a certain service), even if another slice has good (better) signal.

A network may capture information relevant to slice specific reselection as configuration information (e.g., in a LoggedMeasurementConfiguration). In some cases, enhanced logged measurement configuration information may include one or more of: a list of Slice IDs or slice group IDs on which measurements are to be performed, priority of the target slices for the logged MDT report when multiple slices are configured (e.g., URLLC should be performed instead of eMBB), and area specific frequency priority.

In certain cases, the enhanced logged MDT procedure may also record when multiple sources are configured. A UE will send a MDT report including LoggedMeasurementConfiguration to a network entity. In response, a network entity (e.g., a BS) will optimize the enhanced logged MDT procedure and transmit the procedure to a UE. The UE will perform an MDT procedure in accordance with the enhanced logged MIDT received from the BS. For example, a UE may only measure this slice ID, based on priorities in the enhanced logged MDT.

According to certain aspects, a UE may make an MDT measurement of a targeted area only if that area is serving a desired slice. For example, where a UE in inactive mode is supporting an eMBB slice, and the logged MDT configuration instructs a UE to only measure URLLC slices, a UE will not measure its current connection with the eMBB slice because it is not a URLLC slice. Other specified slices may include, for example, RSRP and reference signal received quality (RSRQ). This slice-specific measurement configuration may allow the UE to save power. In one case, a UE may start MDT measurement when the single-network slice selection assistance information (S-NSSAI) (i.e., the slice ID) is included in the requested NSSAI of AS. In a different case, a UE may start MDT measurement when the S-NSSAI is included in allowed NSSAI.

According to certain aspects, an enhanced logged MDT report may include a Slice ID or slice group ID along with logged MDT measurements of that slice (or slice group). The report may be transmitted from a UE to a BS.

According to certain aspects, a wireless node (e.g., a BS or UE) can make slice-specific MRO enhancements to optimize slice service continuity. Currently, handover (HO) report is sent from a target network (e.g. a next generation radio access network (NG-RAN)) to a source network on an interface (e.g., Xn/NG). The report may describe a legacy HO failure event or critical mobility problem using source and target cell CGIs, a radio link failure (RLF) report if available, a HO cause (e.g., too early HO, too late HO, HO to wrong cell, etc.), and any other relevant information.

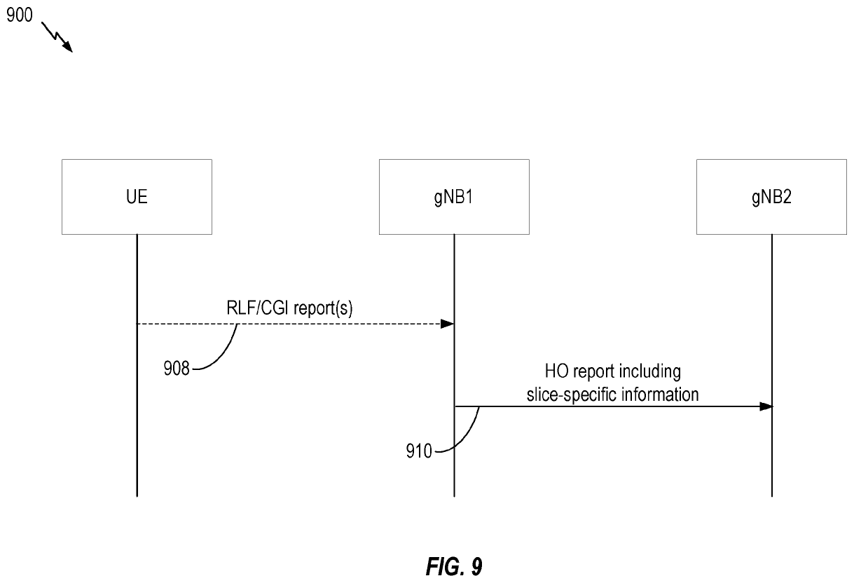

To improve the handover report, a wireless node may enhance an HO report to include slice specific information in cases where an inter-slice HO failed because of a radio link problem (e.g., too early inter-slice HO, too late inter-slice HO, Inter-slice HO to wrong cell), according to certain aspects of the present disclosure. This is illustrated in the call flow diagram 900 of FIG. 9.

As illustrated in FIG. 9, a first gNB (gNB1) may enhance an HO report sent to a second gNB (gNB2) with slice specific information. For example, a UE may send a RLF/CGI report 908 to gNB1. The report may indicate a HO failure event, including an inter-slice HO failure. In response to the report, gNB1 may alert a second gNB2 of the RLF/CGI in the report by sending an HO report 910 which includes slice-specific information regarding the failure.

In some cases, where an inter-slice HO procedure fails because a UE was moved from eMBB slice to an incompatible URLLC slice, one node may report to a neighboring node that the HO procedure failed because it was an inter-slice HO. In this enhanced HO report, a target node may transmit the report on an interface to include source slice or slice group ID or registration area, target slice or slice group ID or registration area, an indication that a HO was an inter-slice HO, new HO causes (e.g., mobility due to different slice support), and slice remapping and fallback decisions.

According to certain aspects, an HO report can also capture issues during successful handover. For example, an enhanced HO report may capture remote line module issues during successful handover. In certain cases, an HO report may be sent by the UE to a BS. The BS may then share the report among itself among other networks.

According to certain aspects, an enhanced successful HO Report on either the network side (e.g., Xn/NG/F1) or on UE side (e.g., RRC) may include source slice or slice group ID or RA, target slice or slice group ID or RA, an indication that this was an inter-slice handover, interruption time (if any) due to slice remapping, UE knowledge of slice remapping, if present, and an indication that load for a certain slice is “high” (i.e., beyond X %) in target cell. A high load during a successful HO is measurable by a BS and may indicate that the HO procedure might need load balancing. In response to an advanced HO report, a source BS may, for example, detect a high load on a target BS and in response, may search for a different cell for which to HO the UE. In certain cases, the UE may be aware of slice remapping.

A UE may also use slice specific information to enhance RLF reports. Currently, a UE sends and RLF report to assist a network in identifying coverage holes with the following information: Previous cell information (e.g., CGI), failed cell information (e.g., CGI), reconnect cell information (e.g., CGI), RLF cause, time until reconnection, time since failure, and other relevant information.

According to certain aspects of the present disclosure, a UE may enhance a RLF report to include slice specific information like slice or slice group ID or registration area of a previous/failed/reconnect cell. A UE may send an enhanced RLF report to a network entity (e.g., a BS) including the following slice specific information: Source slice or slice group ID or RA, target slice or slice group ID or RA, an indication that this was an inter-slice handover, and interruption time (if any) due to slice remapping. In response, the receiving BS will add configured load information for the RLF to the RLF report, and send the report to a neighboring BS.

A UE may also use slice specific information to enhance connection establishment failure (CEF) reports. Currently, a UE sends and RLF report to assist a results of failed cell and neighboring cells along with cell information (e.g., CGI), number of connection failures, and time since failure,

According to certain aspects of the present disclosure, a UE may enhance a CEF report to include slice specific information. Such information may include one or more of: a Slice or slice group ID or registration area of failed cells and number of connection failures per slice ID. A UE may send an enhanced CEF report to a network entity (e.g., a BS) including the following slice specific information: Source slice or slice group ID or registration area, target slice or slice group ID or registration area, an indication that this was an inter-slice handover, and interruption time (if any) due to slice remapping. In response, the receiving BS may add configured load information for the CEF to the CEF report, and send the report to a neighboring BS.

### Example Methods

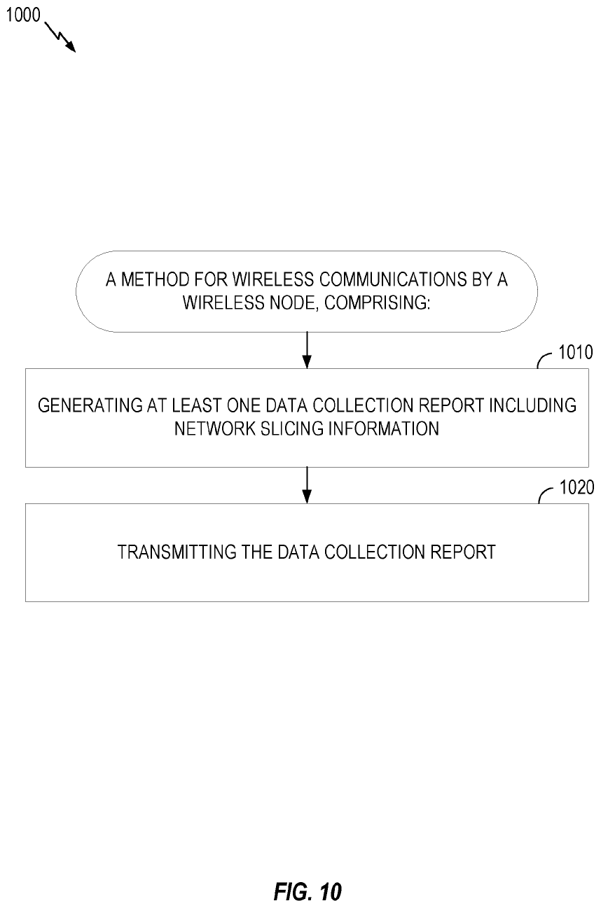

FIG. 10 illustrates example operations for wireless communications by a wireless node, in accordance with some aspects of the present disclosure.

At 1010, the wireless node may generate at least one data collection report including network slicing information. In one example, the wireless node may generate a data collection report based on a RACH procedure. In another example, a wireless node may generate a data collection report based on a MDT procedure.

At 1020, the wireless node may transmit the data collection report. In one example, the data collection report may contain slice-specific information like an S-NSSAI.

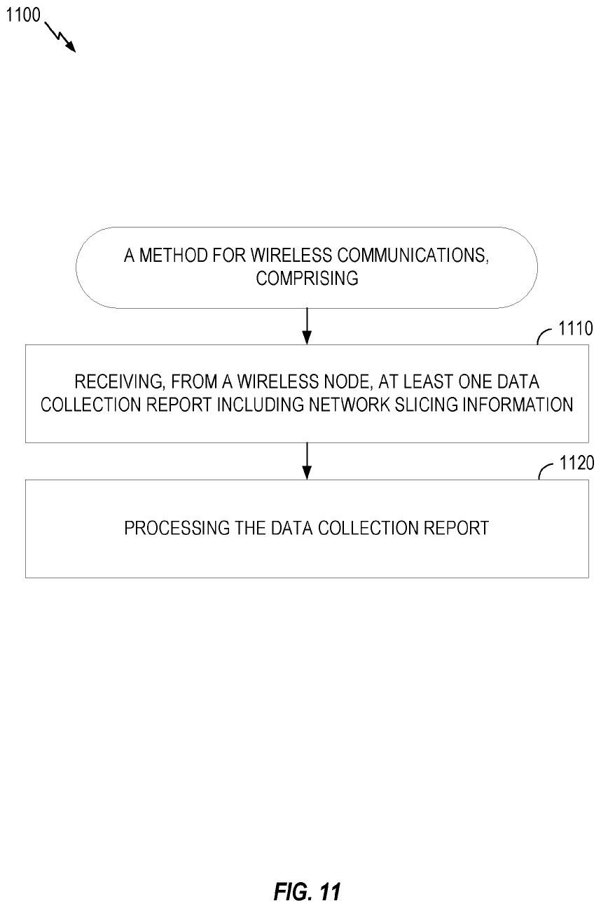

FIG. 11 illustrates example operations for wireless communications by a wireless node, in accordance with some aspects of the present disclosure.

At 1110, the wireless node may receive, from a wireless node, at least one data collection report including network slicing information. In one example, the wireless node may receive a data collection report based on a RLF procedure. In another example, a wireless node may receive a data collection report based on a CEF procedure.

At 1120, the wireless node may process the data collection report. In one example, the wireless node may process the data collection report to optimize a NG-RAN procedure based on slicing information.

### Example Wireless Communication Devices

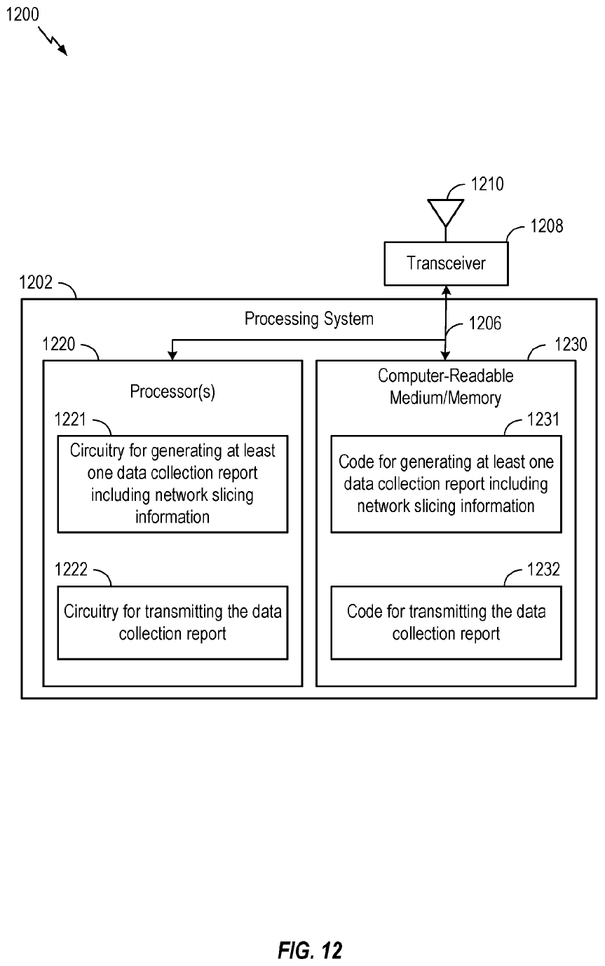

FIG. 12 depicts an example communications device 1200 that includes various components operable, configured, or adapted to perform operations for the techniques disclosed herein, such as the operations depicted and described with respect to FIG. 10 In some examples, communication device 1200 may be a base station 102 as described, for example with respect to FIGS. 1 and 2.

Communications device 1200 includes a processing system 1202 coupled to a transceiver 1208 (e.g., a transmitter and/or a receiver). Transceiver 1208 is configured to transmit (or send) and receive signals for the communications device 1200 via an antenna 1210, such as the various signals as described herein. Processing system 1202 may be configured to perform processing functions for communications device 1200, including processing signals received and/or to be transmitted by communications device 1200.

Processing system 1202 includes one or more processors 1220 coupled to a computer-readable medium/memory 1230 via a bus 1206. In certain aspects, computer-readable medium/memory 1230 is configured to store instructions (e.g., computer-executable code) that when executed by the one or more processors 1220, cause the one or more processors 1220 to perform the operations illustrated in FIG. 10, or other operations for performing the various techniques discussed herein to transmit or receive data collection reports based on slicing information.

In the depicted example, computer-readable medium/memory 1230 stores code 1231 for generating at least one data collection report including network slicing information, and code 1232 for transmitting the data collection report.

In the depicted example, the one or more processors 1220 include circuitry configured to implement the code stored in the computer-readable medium/memory 1230, including circuitry 1221 for generating at least one data collection report including network slicing information, and circuitry 1222 for transmitting the data collection report.

Various components of communications device 1200 may provide means for performing the methods described herein, including with respect to FIG. 10.

In some examples, means for transmitting or sending (or means for outputting for transmission) may include the transceivers 232 and/or antenna(s) 234 of the base station 102 illustrated in FIG. 2 and/or transceiver 1208 and antenna 1210 of the communication device 1200 in FIG. 12.

In some examples, means for receiving (or means for obtaining) may include the transceivers 232 and/or antenna(s) 234 of the base station illustrated in FIG. 2 and/or transceiver 1208 and antenna 1210 of the communication device 1200 in FIG. 12.

In some examples, means for generating at least one data collection report including network slicing information and transmitting the data collection report may include various processing system components, such as: the one or more processors 1220 in FIG. 12, or aspects of the base station 102 depicted in FIG. 2, including receive processor 238, transmit processor 220, TX MIMO processor 230, and/or controller/processor 240 (including data collection report component 241).

Notably, FIG. 12 is an example, and many other examples and configurations of communication device 1200 are possible.

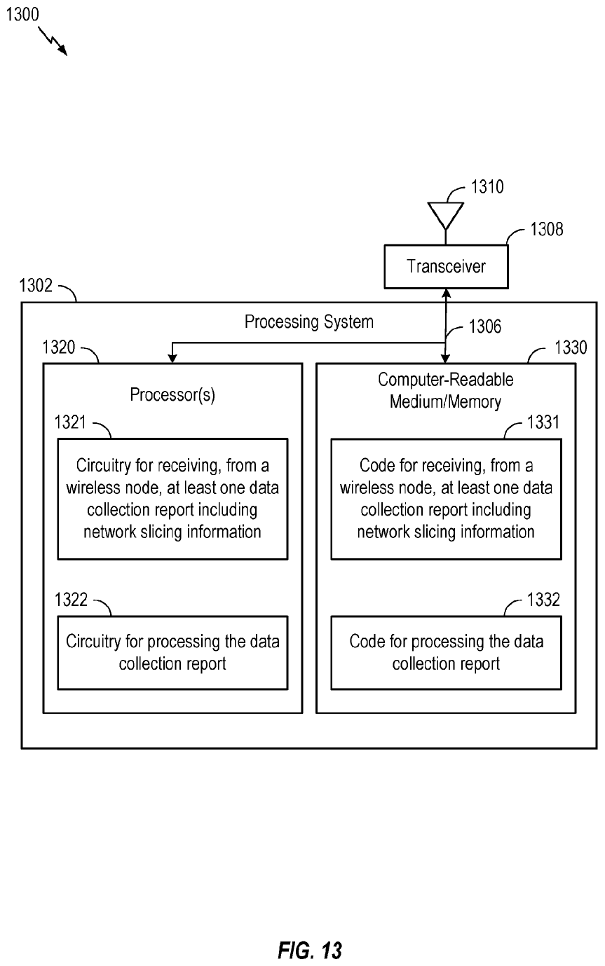

FIG. 13 depicts an example communications device 1300 that includes various components operable, configured, or adapted to perform operations for the techniques disclosed herein, such as the operations depicted and described with respect to FIG. 11. In some examples, communication device 1300 may be a user equipment 104 as described, for example with respect to FIGS. 1 and 2.

Communications device 1300 includes a processing system 1302 coupled to a transceiver 1308 (e.g., a transmitter and/or a receiver). Transceiver 1308 is configured to transmit (or send) and receive signals for the communications device 1300 via an antenna 1310, such as the various signals as described herein. Processing system 1302 may be configured to perform processing functions for communications device 1300, including processing signals received and/or to be transmitted by communications device 1300.

Processing system 1302 includes one or more processors 1320 coupled to a computer-readable medium/memory 1330 via a bus 1306. In certain aspects, computer-readable medium/memory 1330 is configured to store instructions (e.g., computer-executable code) that when executed by the one or more processors 1320, cause the one or more processors 1320 to perform the operations illustrated in FIG. 11, or other operations for performing the various techniques discussed herein to transmit or receive data collection reports based on slicing information.

In the depicted example, computer-readable medium/memory 1330 stores code 1331 for receiving, from a wireless node, at least one data collection report including network slicing information, and code 1332 for processing the data collection report.

In the depicted example, the one or more processors 1320 include circuitry configured to implement the code stored in the computer-readable medium/memory 1330, including circuitry 1321 for receiving, from a wireless node, at least one data collection report including network slicing information, and circuitry 1322 for processing the data collection report.

Various components of communications device 1300 may provide means for performing the methods described herein, including with respect to FIG. 11.

In some examples, means for transmitting or sending (or means for outputting for transmission) may include the transceivers 254 and/or antenna(s) 252 of the user equipment 104 illustrated in FIG. 2 and/or transceiver 1308 and antenna 1310 of the communication device 1300 in FIG. 13.

In some examples, means for receiving (or means for obtaining) may include the transceivers 254 and/or antenna(s) 252 of the user equipment 104 illustrated in FIG. 2 and/or transceiver 1308 and antenna 1310 of the communication device 1300 in FIG. 13.

In some examples, means for receiving, from a wireless node, at least one data collection report including network slicing information and processing the data collection report may include various processing system components, such as: the one or more processors 1320 in FIG. 13, or aspects of the user equipment 104 depicted in FIG. 2, including receive processor 258, transmit processor 264, TX MIMO processor 266, and/or controller/processor 280 (including data collection report component 281).

Notably, FIG. 13 is an example, and many other examples and configurations of communication device 1300 are possible.

### Example Clauses

Implementation examples are described in the following numbered clauses:

Clause 1. A method for wireless communications by a wireless node, comprising: generating at least one data collection report including network slicing information; and transmitting the data collection report.

Clause 2. The method of Clause 1, wherein the at least one data collection report comprises at least one of a Self-Organizing Network (SON) report or Minimization of Drive Testing (MDT) report.

Clause 3. The method of any one of Clauses 1-2, wherein: the wireless node comprises a user equipment (UE); transmitting the data collection report comprises transmitting the data collection report to a network entity; the data collection report comprises a random access channel (RACH) report; and the method further comprises receiving, from the network entity, configuration information indicating slice-specific RACH resources based on the network slicing information included in the RACH report.

Clause 4. The method of Clause 3, wherein the network slicing information comprises at least one of: a Slice identifier (ID) or slice group ID; a slice specific threshold used for a RACH type selection; an indication of whether a slice specific RACH resource was used per random access attempt; or an indication of a RACH cause per random access attempt.

Clause 5. The method of Clause 3, wherein the network slicing information comprises at least one of: a number of times an ongoing RACH procedure was aborted due to a higher priority RACH procedure; a number of times a new RACH procedure was suspended due to an ongoing higher priority RACH procedure; or an indication of a collision between a slice specific RACH parameter prioritization and a legacy random access prioritization.

Clause 6. The method of any one of Clauses 1-5, wherein: the data collection report comprises a next generation radio access network (NG-RAN) measurement report.

Clause 7. The method of Clause 6, wherein the network slicing information included in the NG-RAN measurement report comprises at least one of: a number of random access attempts per slice; a number of UEs which accessed a slice-specific RACH resource; or a number of active UEs per slice.

Clause 8. The method of any one of Clauses 1-7, wherein: the wireless node comprises a user equipment (UE); transmitting the data collection report comprises transmitting the data collection report to a network entity; the data collection report comprises a logged minimization of drive test (MDT) report; and the method further comprises receiving, from the network entity, configuration information indicating slice-specific MDT measurement parameters.

Clause 9. The method of Clause 8, wherein the slice-specific MDT measurement parameters comprise at least one of: a list of one or more slice identifiers (IDs) or slice group IDs for which measurements are to be performed; a priority of target slices for the logged MDT report when multiple slices are configured; or an area specific frequency priority for measurements to be included in the logged MDT report.

Clause 10. The method of Clause 8, wherein the network slicing information included in the logged MDT report comprises at least one of a slice identifier (ID) or a slice group ID along with logged MDT measurements of that slice corresponding to the slice ID or slice group ID.

Clause 11. The method of Clause 8, wherein: the data collection report comprises a handover report; and the network slicing information included in the handover report relates to a failed inter-slice handover.

Clause 12. The method of Clause 11, wherein the network slicing information comprises at least one of: a source slice, a source slice group identifier (ID) or a registration area; a target slice, a target slice group ID, or RA; an indication of an inter-slice handover; a handover cause; or a slice remapping or fallback decision.

Clause 13. The method of any one of Clauses 1-12, wherein: the data collection report comprises a handover report; and the network slicing information included in the handover report relates to one or more issues that occurred during a successful inter-slice handover.

Clause 14. The method of Clause 13, wherein the network slicing information comprises at least one of: a source slice, source slice group identifier (ID) or a registration area; a target slice, target slice group ID, or RA; an indication of an inter-slice handover; an indication of interruption time due to slice remapping; an indication of UE knowledge of slice remapping; or an indication that a load for a certain slice is beyond a threshold in a target cell.

Clause 15. The method of any one of Clauses 1-14, wherein: the wireless node comprises a user equipment (UE); transmitting the data collection report comprises transmitting the data collection report to a network entity; and the data collection report comprises a radio link failure (RLF) report.

Clause 16. The method of Clause 15, wherein the network slicing information comprises at least one of: a slice identifier (ID), slice group ID, or registration area of a cell associated with the RLF report; or an RLF cause.

Clause 17. The method of any one of Clauses 1-16, wherein: the wireless node comprises a user equipment (UE); transmitting the data collection report comprises transmitting the data collection report to a network entity; and the data collection report comprises a connection establishment failure (CEF) report.

Clause 18. The method of Clause 17, wherein the network slicing information comprises at least one of: a slice identifier (ID), slice group ID, or a registration area of a cell associated with the CEF report; or a number of connection failures per slice ID.

Clause 19. A method for wireless communications, comprising: receiving, from a wireless node, at least one data collection report including network slicing information; and processing the data collection report.

Clause 20. The method of Clause 19, wherein the at least one data collection report comprises at least one of a Self-Organizing Network (SON) report or Minimization of Drive Testing (MDT) report.

Clause 21. The method of any one of Clauses 19-20, wherein: the wireless node comprises a user equipment (UE); the data collection report comprises a random access channel (RACH) report; processing the data collection report comprises determining slice-specific RACH resources based on the network slicing information included in the RACH report; and the method further comprises transmitting, to the UE, configuration information indicating the slice-specific RACH resources.

Clause 22. The method of Clause 20, wherein the network slicing information comprises at least one of: a Slice identifier (ID) or slice group ID; a slice specific threshold used for a RACH type selection; an indication of whether a slice specific RACH resource was used per random access attempt; or an indication of a RACH cause per random access attempt.

Clause 23. The method of Clause 20, wherein the network slicing information comprises at least one of: a number of times an ongoing RACH procedure was aborted due to a higher priority RACH procedure; a number of times a new RACH procedure was suspended due to an ongoing higher priority RACH procedure; or an indication of a collision between a slice specific RACH parameter prioritization and a legacy random access prioritization.

Clause 24. The method of any one of Clauses 19-23, wherein: the data collection report comprises a next generation radio access network (NG-RAN) measurement report.

Clause 25. The method of Clause 24, wherein the network slicing information included in the NG-RAN measurement report comprises at least one of: a number of random access attempts per slice; a number of UEs which accessed a slice-specific RACH resource; or a number of active UEs per slice.

Clause 26. The method of any one of Clauses 19-25, wherein: the wireless node comprises a user equipment (UE); the data collection report comprises a logged minimization of drive test (MDT) report; and processing the data collection report comprises determining slice-specific MDT measurement parameters based on the network slicing information included in the MDT report; the method further comprises transmitting, to the UE, configuration information indicating the slice-specific MDT measurement parameters.

Clause 27. The method of Clause 26, wherein the slice-specific MDT measurement parameters comprise at least one of: a list of one or more slice identifiers (IDs) or slice group IDs for which measurements are to be performed; a priority of target slices for the logged MDT report when multiple slices are configured; or an area specific frequency priority for measurements to be included in the logged MDT report.

Clause 28. The method of Clause 26, wherein the network slicing information included in the logged MDT report comprises at least one of a slice identifier (ID) or a slice group ID along with logged MDT measurements of that slice corresponding to the slice ID or slice group ID.

Clause 29. The method of any one of Clauses 19-28, wherein: the data collection report comprises a handover report; and the network slicing information included in the handover report relates to a failed inter-slice handover.

Clause 30. The method of Clause 29, wherein the network slicing information comprises at least one of: a source slice, source slice group identifier (ID) or registration area; a target slice, target slice group ID, or RA; an indication of an inter-slice handover; a handover cause; or a slice remapping or fallback decision.

Clause 31. The method of any one of Clauses 19-30, wherein: the data collection report comprises a handover report; and the network slicing information included in the handover report relates to one or more issues that occurred during a successful inter-slice handover.

Clause 32. The method of Clause 31, wherein the network slicing information comprises at least one of: a source slice, source slice group identifier (ID) or registration area; a target slice, target slice group ID, or RA; an indication of an inter-slice handover; an indication of interruption time due to slice remapping; an indication of UE knowledge of slice remapping; or an indication that a load for a certain slice is beyond a threshold in a target cell.

Clause 33. The method of any one of Clauses 19-32, wherein: the wireless node comprises a user equipment (UE); and the data collection report comprises a radio link failure (RLF) report.

Clause 34. The method of Clause 33, wherein the network slicing information comprises at least one of: a slice identifier (ID), slice group ID, or registration area of a cell associated with the RLF report; or an RLF cause.

Clause 35. The method of any one of Clauses 19-34, wherein: the wireless node comprises a user equipment (UE); and the data collection report comprises a connection establishment failure (CEF) report.

Clause 36. The method of Clause 35, wherein the network slicing information comprises at least one of: a slice identifier (ID), slice group ID, or registration area of a cell associated with the CEF report; or a number of connection failures per slice ID.

Clause 37: An apparatus, comprising: a memory comprising executable instructions; one or more processors configured to execute the executable instructions and cause the apparatus to perform a method in accordance with any one of Clauses 1-36.

Clause 38: An apparatus, comprising means for performing a method in accordance with any one of Clauses 1-36.

Clause 39: A non-transitory computer-readable medium comprising executable instructions that, when executed by one or more processors of an apparatus, cause the apparatus to perform a method in accordance with any one of Clauses 1-36.

Clause 40: A computer program product embodied on a computer-readable storage medium comprising code for performing a method in accordance with any one of Clauses 1-36.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mm Wave frequencies in communication with the UE 104. When the gNB 180 operates in mmWave or near mm Wave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of wireless network reporting using radio access network (RAN) slicing information in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a wireless node, comprising:
generating at least one data collection report including network slicing information; and
transmitting the data collection report.

2. The method of claim 1, wherein the at least one data collection report comprises at least one of a Self-Organizing Network (SON) report or Minimization of Drive Testing (MDT) report.

3. The method of claim 1, wherein:
the wireless node comprises a user equipment (UE);
transmitting the data collection report comprises transmitting the data collection report to a network entity;
the data collection report comprises a random access channel (RACH) report; and
the method further comprises receiving, from the network entity, configuration information indicating slice-specific RACH resources based on the network slicing information included in the RACH report.

4. The method of claim 3, wherein the network slicing information comprises at least one of:
a Slice identifier (ID) or slice group ID;
a slice specific threshold used for a RACH type selection;
an indication of whether a slice specific RACH resource was used per random access attempt; or
an indication of a RACH cause per random access attempt.

5. The method of claim 3, wherein the network slicing information comprises at least one of:
a number of times an ongoing RACH procedure was aborted due to a higher priority RACH procedure;
a number of times a new RACH procedure was suspended due to an ongoing higher priority RACH procedure; or
an indication of a collision between a slice specific RACH parameter prioritization and a legacy random access prioritization.

6. The method of claim 1, wherein:
the data collection report comprises a next generation radio access network (NG-RAN) measurement report.

7. The method of claim 6, wherein the network slicing information included in the NG-RAN measurement report comprises at least one of:
a number of random access attempts per slice;
a number of UEs which accessed a slice-specific RACH resource; or
a number of active UEs per slice.

8. The method of claim 1, wherein:
the wireless node comprises a user equipment (UE);
transmitting the data collection report comprises transmitting the data collection report to a network entity;
the data collection report comprises a logged minimization of drive test (MDT) report; and
the method further comprises receiving, from the network entity, configuration information indicating slice-specific MDT measurement parameters.

9. The method of claim 8, wherein the slice-specific MDT measurement parameters comprise at least one of:
a list of one or more slice identifiers (IDs) or slice group IDs for which measurements are to be performed;
a priority of target slices for the logged MDT report when multiple slices are configured; or
an area specific frequency priority for measurements to be included in the logged MDT report.

10. The method of claim 8, wherein the network slicing information included in the logged MDT report comprises at least one of a slice identifier (ID) or a slice group ID along with logged MDT measurements of that slice corresponding to the slice ID or slice group ID.

11. The method of claim 8, wherein:
the data collection report comprises a handover report; and
the network slicing information included in the handover report relates to a failed inter-slice handover.

12. The method of claim 11, wherein the network slicing information comprises at least one of:
a source slice, a source slice group identifier (ID) or a registration area, a target slice, a target slice group ID, registration area, an indication of an inter-slice handover, a handover cause, a slice remapping or a fallback decision.

13. The method of claim 1, wherein:
the data collection report comprises a handover report; and
the network slicing information included in the handover report relates to one or more issues that occurred during a successful inter-slice handover.

14. The method of claim 13, wherein the network slicing information comprises at least one of:
a source slice, source slice group identifier (ID), a target slice, target slice group ID, a registration area, an indication of an inter-slice handover, an indication of interruption time due to slice remapping, an indication of UE knowledge of slice remapping, or an indication that a load for a certain slice is beyond a threshold in a target cell.

15. The method of claim 1, wherein:
the wireless node comprises a user equipment (UE);
transmitting the data collection report comprises transmitting the data collection report to a network entity; and
the data collection report comprises a radio link failure (RLF) report.

16. The method of claim 15, wherein the network slicing information comprises at least one of:
a slice identifier (ID), slice group ID, or registration area of a cell associated with the RLF report; or
an RLF cause.

17. The method of claim 1, wherein:
the wireless node comprises a user equipment (UE);
transmitting the data collection report comprises transmitting the data collection report to a network entity; and
the data collection report comprises a connection establishment failure (CEF) report.

18. The method of claim 17, wherein the network slicing information comprises at least one of:
a slice identifier (ID), slice group ID, or a registration area of a cell associated with the CEF report; or
a number of connection failures per slice ID.

19. A method for wireless communications, comprising:
receiving, from a wireless node, at least one data collection report including network slicing information; and
processing the data collection report.

20. The method of claim 19, wherein the at least one data collection report comprises at least one of a Self-Organizing Network (SON) report or Minimization of Drive Testing (MDT) report.

21. The method of claim 19, wherein:
the wireless node comprises a user equipment (UE);
the data collection report comprises a random access channel (RACH) report;
processing the data collection report comprises determining slice-specific RACH resources based on the network slicing information included in the RACH report; and
the method further comprises transmitting, to the UE, configuration information indicating the slice-specific RACH resources.

22. The method of claim 19, wherein:
the data collection report comprises a next generation radio access network (NG-RAN) measurement report.

23. The method of claim 19, wherein:
the wireless node comprises a user equipment (UE);
the data collection report comprises a logged minimization of drive test (MDT) report;
processing the data collection report comprises determining slice-specific MDT measurement parameters based on the network slicing information included in the MDT report; and
the method further comprises transmitting, to the UE, configuration information indicating the slice-specific MDT measurement parameters.

24. The method of claim 19, wherein:
the data collection report comprises a handover report; and
the network slicing information included in the handover report relates to a failed inter-slice handover.

25. The method of claim 19, wherein:
the data collection report comprises a handover report; and
the network slicing information included in the handover report relates to one or more issues that occurred during a successful inter-slice handover.

26. The method of claim 25, wherein the network slicing information comprises at least one of:
a source slice, source slice group identifier (ID) or registration area;
a target slice, target slice group ID, or RA;
an indication of an inter-slice handover;
an indication of interruption time due to slice remapping;
an indication of UE knowledge of slice remapping; or
an indication that a load for a certain slice is beyond a threshold in a target cell.

27. The method of claim 19, wherein:
the wireless node comprises a user equipment (UE); and
the data collection report comprises a radio link failure (RLF) report.

28. The method of claim 19, wherein:
the wireless node comprises a user equipment (UE); and
the data collection report comprises a connection establishment failure (CEF) report.

29. A wireless node, comprising:
a memory; and
a processor coupled to the memory, the processor and the memory configured to:
generate at least one data collection report including network slicing information; and
transmit the data collection report.

30. An apparatus, comprising:
a memory; and
a processor coupled to the memory, the processor and the memory configured to:
receive, from a wireless node, at least one data collection report including network slicing information; and
process the data collection report.
